(19) United States
(12) Patent Application Publication
(10) Pub. No.: US 2021/0026134 A1
(43) Pub. Date: Jan. 28, 2021

(54) HEADS-UP DISPLAY (HUD) MIRROR ASSEMBLY WITH SWITCHABLE MIRROR LAYER

(71) Applicants: DENSO International America, Inc., Southfield, MI (US); Denso Corporation, Kariya (JP)

(72) Inventor: Ian HARKINS, Flat Rock, MI (US)

(21) Appl. No.: 16/517,746

(22) Filed: Jul. 22, 2019

(51) Int. Cl. G02B 27/01; G02F 1/1334

(52) U.S. Cl. CPC G02B 27/0101; G02F 1/1334; B60K 35/00; G02B 2027/0141; G02B 2027/0118

(57) ABSTRACT

A heads-up display (HUD) system for a vehicle is provided. A light source is configured to transmit a light. A mirror is configured to reflect the light toward a window (e.g., windshield) of the vehicle. The mirror has a front reflective surface and a rear reflective surface located further from the light source than the front reflective surface. A controller is programmed to selectively alter a transparency of the front reflective surface. The alteration of the transparency of the front reflective surface enables the front reflective surface to alter between a reflective mode in which the light reflects off the front reflective surface and toward the windshield, and a transparent mode in which the light transmits through the front reflective surface and instead reflects off of the rear reflective surface.

### TECHNICAL FIELD

The present disclosure relates to a heads-up display (HUD) assembly and a system having a mirror that can alter in transparency or reflectiveness.

### BACKGROUND

Various automotive vehicles have a heads-up display (HUD) system. In a HUD system, a light source projects a light, which is reflected onto a windshield of the vehicle. The focal point of the light is out beyond the vehicle, enabling the driver of the vehicle to view the light on the windshield without changing focus while looking at the outside environment.

### SUMMARY

According to one embodiment, a heads-up display (HUD) system for a vehicle is provided. A light source is configured to transmit a light. A mirror is configured to reflect the light onto a window of the vehicle, the mirror having a front reflective surface and a rear reflective surface located further from the light source than the front reflective surface. A controller is programmed to selectively alter a transparency of the front reflective suffice.

In another embodiment, a HUD system for a vehicle includes a light source configured to transmit a light, and a switchable mirror configured to reflect the light toward a windshield of the vehicle, with at least a portion of the switchable mirror being switchable between a transparent mode and a reflective mode.

In yet another embodiment, a switchable mirror for a HUD system is provided. The switchable mirror includes a first layer having a first substrate, a second layer directly adjacent the first layer and having a switchable reflective surface, and a third layer directly adjacent the second layer and having a second substrate. A fourth layer is directly adjacent the third layer and has a non-switchable reflective suffice. The switchable reflective surface is controllable to selectively permit light to transmit therethrough, through the second substrate, and reflect off of the non-switchable reflective surface and to a windshield of a vehicle.

### BRIEF DESCRIPTION OF THE DRAWINGS

FIG. 1 illustrates a block diagram of a vehicle system for controlling a heads-up display (HUD), according to one embodiment.

FIG. 2A illustrates a side schematic view of a HUD system with an electrically-controlled mirror surface configured to alter its transparency, according to one embodiment; FIG. 2B illustrates a schematic view of the HUD system displaying various zones on a windshield of a vehicle, according to one embodiment.

FIG. 3A illustrates a front view of a mirror of the HUD system; FIG. 3B illustrates a cross-sectional view along section A-A of FIG. 3A; and FIG. 3C illustrates an enlarged portion of the cross-sectional view of FIG. 3B, illustrating substrate layers of the mirror.

FIG. 4 illustrates a top view of the mirror of the HUD system, according to one embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

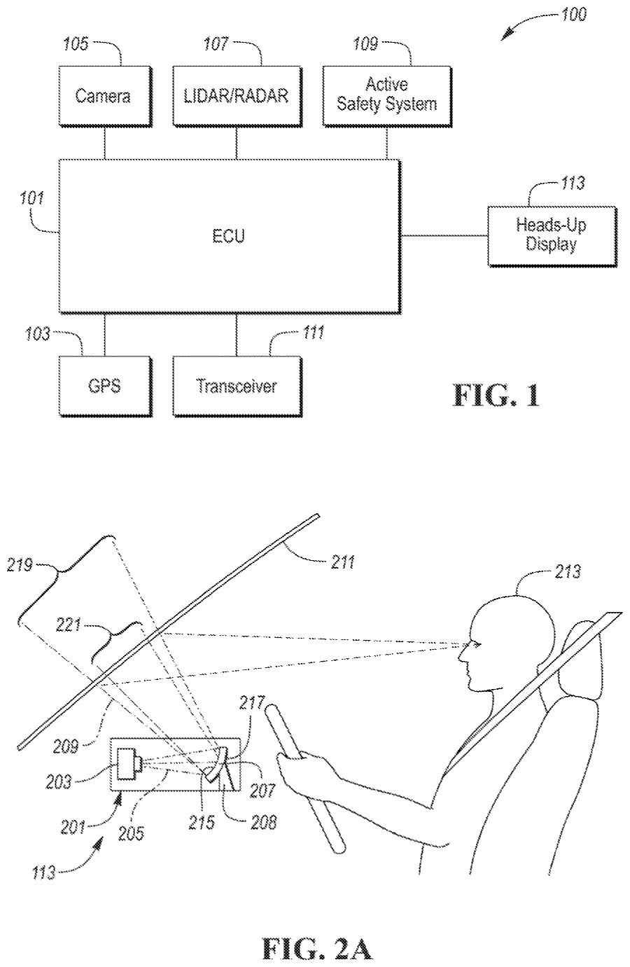

FIG. 1 illustrates an example block diagram of a vehicle system 100. The system 100 is configured for an automotive vehicle (e.g., passenger car, truck, SUV, van, autonomous vehicle, etc.). The system can also be configured for non-automotive applications, such as boats, trains, planes, tanks, etc. The system 100 may include a controller 101. The controller 101 may be a vehicle controller such as an electronic control unit (ECU). The controller 101, also referred to herein as ECU 101, may be embodied in a processor configured to carry out instructions for the methods and systems described herein.

The system 100 may include a global positioning system (GPS) 103 or global navigation satellite system (GNSS). The GPS 103 of the vehicle may be configured to generate GPS/GNSS data for the vehicle, such as via a transceiver communicating with one or more satellites orbiting Earth. The GPS data may indicate a current geographic location of the vehicle, such as by including current longitude and latitude coordinates of the vehicle. The GPS 103 may communicate the GPS data to the controller 101, which may be configured to utilize the UPS data to determine the geographical location of the vehicle, and to correspondingly determine the geographic location of objects (e.g., roadside infrastructure described herein) detected as proximate the vehicle. The controller 101 may also be configured to determine a heading direction of the vehicle based on received GPS/GNSS data indicating a changed position of the vehicle over a short time span one second), suggesting that the vehicle is moving w a direction corresponding to the change in position.

The system 100 may include sensors, such as various cameras, a light detection and ranging (LIDAR) sensor, a radar sensor, an ultrasonic sensor, or other sensor for detecting information about the surroundings of the vehicle, including, for example, other vehicles, lane lines, guard rails, objects in the roadway, buildings, pedestrians, etc. In the example shown in FIG. 1, the system 100 may include a camera 105 configured to view objects in a field of view. The camera 105 may be coupled to an associated image-processor that detects images captured by the camera 105. For example, the image processor may be equipped to detect the presence of a person, a vehicle, a sign, etc. within the field of view. Based on machine-learning capabilities or learning from several user-inputs, the processor can detect these distinct features, and can correspondingly trigger a warning or other safety protocol (e.g., brakes) in response to an object approaching or being within a distance threshold from the vehicle.

The system 100 may also include other sensors, such as LI DAR and radar sensors 107. These sensors also detect objects surrounding the vehicle, and can also trigger a warning or other safety protocol in response to an object approaching or being within a distance threshold from the vehicle. The camera 105, LIDAR and radar sensors 107 can collectively be referred to as object detectors.

The system 100 may also include an active safety system 109. The active safety system 109 may include one or more of the object detectors 105, 107. The active safety system 109 may include a forward collision warning (FCW), autonomous emergency braking (AEB), collision avoidance systems, adaptive cruise control (ACC), lane departure warning (LDW), lane keep assist (LKA), and other sub-systems. Certain information gathered from these active safety sub-systems may cause the HUD system (described below) to alter its operation state (e.g., make a reflective surface transparent) and display corresponding information on the windshield (e.g. “WARNING—APPLY BRAKES”).

The system 100 may also include one or more wireless transceivers 111 configured to facilitate direct wireless communication with other components such as other vehicles, mobile devices of pedestrians or other vehicle occupants, roadside infrastructure, etc. To facilitate such local wireless communications, the transceiver 111 may include one or more of a Bluetooth transceiver, a ZigBee transceiver, a Wi-Fi transceiver, a radio-frequency identification (“RFID”) transceiver, a 4G/5G transceiver, a near-field communication (“NFC”) transceiver, a vehicle-to-vehicle (V2V) transceiver, a vehicle-to-infrastructure (V2I) transceiver, vehicle-to-everything (V2X) transceiver, and/or additional transceivers designed for other RF protocols.

The controller 101 can be any suitable controller for receiving information from other sensors or systems (such as GPS 103, the vehicle camera 105, object detectors 107, active safety systems 109, V2X transceiver, etc.) and correspondingly controlling a heads-up display (HUD) 113 on the vehicle (also described below). In this disclosure, including the definitions below, the terms “controller” and “system” may refer to, be part of, or include processor hardware (shared, dedicated, or group) that executes code and memory hardware (shared, dedicated, or group) that stores code executed by the processor hardware. The “controller” may also be included in the HUD module, or may be on another module such as an instrument cluster (e.g., dumb HUD). The code is configured to provide the features of the controller and systems described herein. In one example, the controller 101 may include a processor, memory, and non-volatile storage. The processor may include one or more devices selected from microprocessors, micro-controllers, digital signal processors, microcomputers, central processing, units, field programmable gate arrays, programmable logic devices, state machines, logic circuits, analog circuits, digital circuits, or any other devices that manipulate signals (analog or digital) based on computer-executable instructions residing in memory. The memory may include a single memory device or a plurality of memory devices including, but not limited to, random access memory (“RAM”), volatile memory, non-volatile memory, static random-access memory (“SRAM”), dynamic random-access memory (“DRAM”), flash memory, cache memory, or any other device capable of storing information. The non-volatile storage may include one or more persistent data storage devices such as a hard drive, optical drive, tape drive, non-volatile solid-state device, or any other device capable of persistently storing information. The processor may be configured to read into memory and execute computer-executable instructions embodying one or more software programs residing in the non-volatile storage. Programs residing in the non-volatile storage may include or be part of an operating system or an application, and may be compiled or interpreted from computer programs created using a variety of programming languages and/or technologies, including, without limitation, and either alone or in combination, Java, C, C++, C#, Objective C, Fortran, Pascal, Java Script, Python, Pert, and PL/SQL. The computer-executable instructions of the programs may be configured, upon execution by the processor, to cause the controller to change the transparency of the mirror, and correspondingly to implement functions, features, and processes of the mirror and light source described herein.

The controller 101 may be in communication with the GPS 103, the vehicle camera 105, object detectors 107, active safety systems 109, transceiver 111, etc. via a direct connection to one or more of these components, such as via various input/output (I/O) ports of the controller 101. Additionally, the controller 101 may communicate with one or more of these other components over one or more in-vehicle networks, such as a vehicle controller area network (CAN), an Ethernet network, a media-oriented system transfer (MOST) network, and a wireless local area network (WLAN).

The heads-up display (HUD) system 113 includes a transparent display that presents data (e.g., on the windshield) without requiring the driver to look away from his/her usual viewpoints. The controller 101 can receive information from the GPS 103, the vehicle camera 105, object detectors 107, active safety systems 109, transceiver 111, etc. and correspondingly output information on the windshield via the HUD system 113. For example, the controller 101 can cause the HUD system 113 to display information regarding the status of the vehicle, such as the speed, location, turn-by-turn navigation instructions, and other information. In another example, the controller 101 can cause the HUD system 113 to display a warning in response to one or more object detectors 107 sensing an object that has potential for a collision (e.g., an object being within a threshold distance from the vehicle, or the distance between the vehicle and the object decreasing at a rate above a threshold). In such a situation, the warning displayed via the HUD system 113 may be similar to or activated with other warnings (e.g., sound, dashboard, active brakes, etc.) that are initiated in response to detecting such objects.

HUD systems are often times subjected to strict packaging constraints. For example, the HUD system may have a light source for transmitting light, one or more lenses and/or minors for altering the light's path, and a housing for containing these and other potential components. These components are typically packaged in or around the dash, where packaging is already constrained. Moreover, if the display area of the HUD system were desired to increase or decrease during operation, it may require additional mirrors or light sources that would make packaging even more difficult

According to various embodiments described herein, a HUD system is provided with a combiner having a switchable (e.g., electronically-controlled) mirror layer or surface. The electronically-controlled mirror surface can be controlled to either be transparent or reflective. This allows the combiner to assume a first state in which light is reflected off of the electronically-controlled mirror surface, and a second state in which the light passes through the electronically-controlled mirror surface and instead reflects off of a second mirror surface. The reflective characteristics of the electronically-controlled mirror surface and the second mirror surface can differ so that different viewing capabilities are presented on the windshield depending upon which state the combiner is in. This allows a single mirror unit with two reflective surfaces to provide different viewing capabilities without impacting packaging spaces by requiring a second mirror unit.

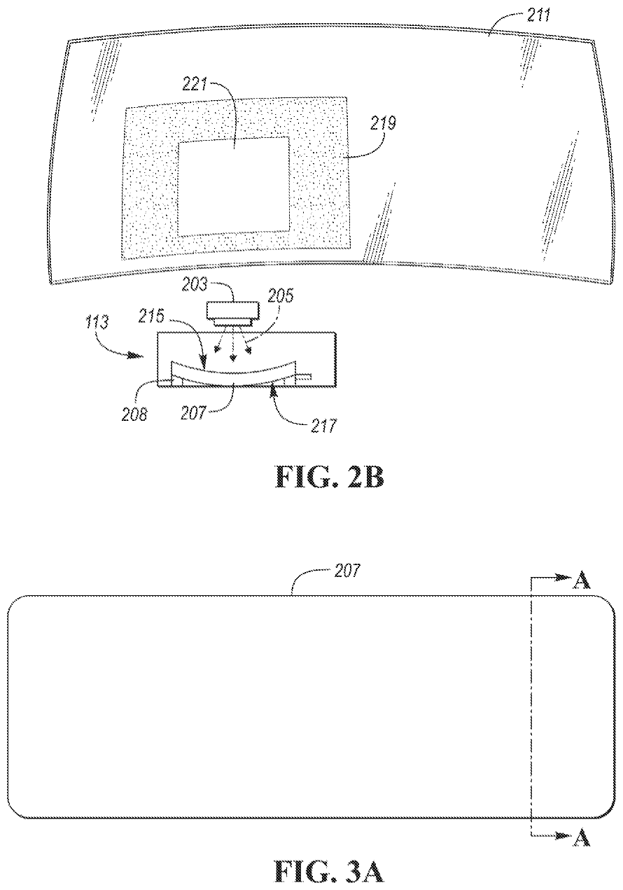

FIGS. 2A and 2B illustrate one example of a HUD system 113 having such characteristics. The HUD system 113 includes a projector unit 201. For simplicity sake, the projector unit 201 is shown herein to have a light source 203, which can be an LED light source for example. Other examples of the light source 203 include a liquid crystal display (LCD), liquid crystal on silicon (LCoS), digital micro-mirrors (DMD), an organic light-emitting diode (OLED), among others. Light transmitted from the light source 203 is shown generally at 205. The light 205 from the light source 203 is reflected off of a concave mirror 207. The mirror 207 may be fixed and held stationary via mirror mount brackets 208. The light reflected off of the mirror 207, shown generally at 209, is then projected and displayed on a vehicle windshield 211, which acts as a combiner to allow a driver 213 of the vehicle to see external objects through the windshield 211 while also seeing the reflected image from the projector unit 201. The windshield 211 can be referred to as a window, and in other embodiments, the HUD system is configured for a window other than the windshield 211, such as a window of a door, a rear window of the vehicle, or other such glass or transparent protective structure.

The projected image is collimated by the mirror 207, which can make the light rays parallel. Because the light rays are parallel, the lens of the human eye may focus at extreme distances (e.g., infinity) to get a clear image. Collimated images on the windshield 211 (acting as a combiner) are perceived as existing at or near optical infinity. This means that the eyes of the driver 213 do not need to refocus to view the outside world and the displayed image. Instead, the image appears to be “out there” and overlaying the outside world instead of on a fixed position on the windshield 211 itself. The driver can remain focused on the outside world and the image appearing on the windshield 211 will remain in focus for the driver.

As will be described in more detail below, the mirror 207 has two reflective surfaces: a front reflective surface 215 and a rear reflective surface 217. The front reflective surface 215 can be controlled (e.g., electronically) to assume a state of either transparency or non-transparency, or a state between full transparency and full non-transparency. When the front reflective surface 215 is transparent, the light 205 passes through the front reflective surface 215 and reflects off of the rear reflective surface 217. This projects an image in a first zone 219 on the windshield 211. It can be said that the HUD system 113 is operating in a first mode, or in a transparent mode.

When the front reflective surface 215 is controlled to be non-transparent, at least some of the light 205 reflects off of the front reflective surface 215 and does not pass to the rear reflective surface 217. This projects an image in a second zone 221 on the windshield 211. It can be said that the HUD system 113 is operating in a second mode, or in a non-transparent mode. The mirror 207 can switch between the first and second modes; the mirror may therefore be referred to as a switchable mirror.

By altering the transparency of the front reflective surface 215 to activate or deactivate the first zone 219, different information can be presented. For example, certain information such as vehicle speed and turn-by-turn directions may be constantly provided in the second zone 221. Then, when the front reflective surface 215 is commanded by the controller 101 to be transparent, the first zone 219 is viewable. Thus, warning information (e.g., “WARNING—APPLY BRAKES,” etc. as explained above with reference to FIG. 1) can be provided in the larger viewing area of the first zone 219.

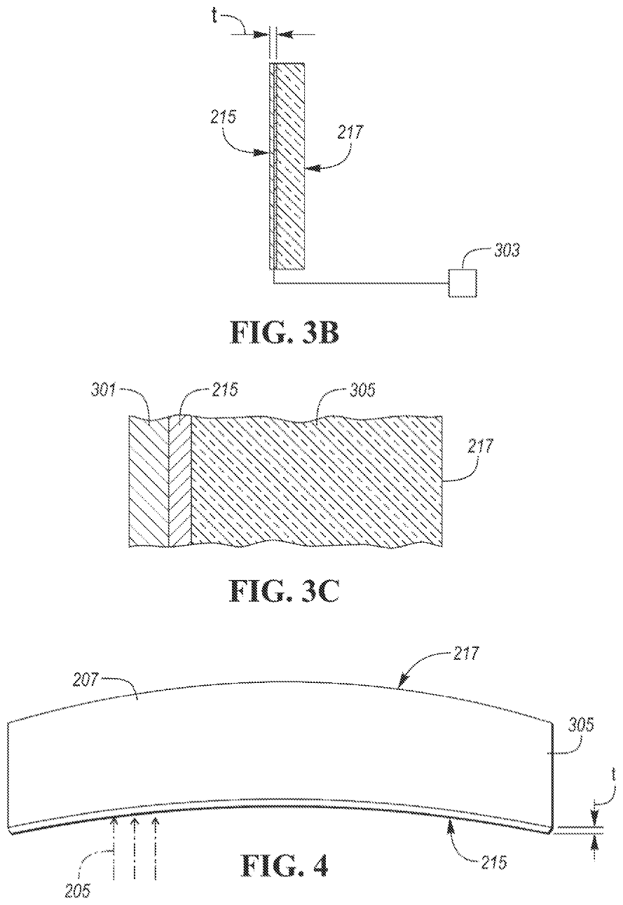

FIGS. 3A-3C show various views of the mirror 207 and its layers. The mirror 207 may be generally concave, or in other embodiments, can be flat. The light from the light source 203 first hits a first substrate 301 at the front of the mirror 207. The first substrate 301 is transparent, such as glass, plexiglass, plastic, or other materials that allow all or a vast majority of light to be transmitted therethrough.

Adjacent to the first substrate 301 is the front reflective surface 215. The front reflective surface 215 can be a thin film mirror, and can be electronically controlled to adjust in transparency. In other words, the front reflective surface 215 can be a switchable mirror layer. The front reflective surface 215 can alter in transparency according to various methods. For example, the front reflective surface or layer 215 can be a liquid crystal glass, with a laminated glass, having two or more clear or colored sheets of glass and a liquid crystal film, assembled between at least two plastic interlayers. The liquid crystals can be commanded to be either aligned or not aligned, which changes the transparency of the glass.

In another embodiment, the front reflective surface or layer 215 includes polymer-dispersed liquid crystal (PDLC) devices dissolved or dispersed into a liquid polymer, followed by solidification or curing of the polymer. In similar embodiments, a PDLC film can be sandwiched between two layers of glass and two layers of conductive interlayers. In a transparent mode, electrical current is passed through the PDLC interlayer, which aligns the crystals along a number of parallel axes, thus allowing vision through the glass.

In yet another embodiment, the front reflective surface or layer 215 includes suspended-particle devices (SPDs). A thin film laminate of rod-like nano-scale particles are suspended in a liquid and placed between two pieces of glass or plastic attached to one layer. When no voltage is applied, the suspended particles are not aligned and can be randomly organized, thus blocking the light. When voltage is applied, the suspended particles align and let light pass through.

In yet another embodiment, the front reflective surface or layer 215 is a switchable glass, in which a simple electrical switch is operated to control the opacity of the glass from clear to translucent or reflective.

In yet another embodiment, the front reflective surface or layer 215 is an electrically switchable trans-reflective mirror that includes a solid-state thin film device made from a liquid crystal material, which can be rapidly switched between pure reflection and total transparency.

In yet another embodiment, the front reflective surface or layer 215 is an electro-chromic glass, in which the light-transmission properties are changed in response to voltage and thus allow control over the amount of light (and heat) passing therethrough.

In yet another embodiment, the front reflective surface or layer 215 is a transition-metal switchable mirror (TMSM) in which glass panels are provided with a coating capable of switching back and forth between a transparent state and a reflective state by application of an electric field (e.g., electrochromic switching) or by exposure to dilute hydrogen gas (e.g., gasochromic switching). The layer 215 may include a transparent conductor layer, a mirror electrode layer, an electrolyte layer, and a transparent conductor/catalyst layer.

In certain embodiments, the transparency of the front reflective surface 215 can be commanded to adjust via a controller, such as controller 303. The controller 303 may be connected to the controller 101 described above, or may be part of the controller 101. The controller 303 may be commanded to adjust the transparency of the front reflective surface 215 as described above.

If the front reflective surface 215 is in a transparent state, the light will then travel through the front reflective surface 215 and into a second substrate 305. The second substrate 305 can again be a material that allows all or a vast majority of light to be transmitted therethrough, such as glass, plastic, etc.

The light that transmits through the second substrate 305 then reflects off of the rear reflective surface 217. The rear reflective surface 217 can be a mirror sheet and need not be controllable to adjust in transparency. In another embodiment, the rear reflective surface 217 may be controllable to adjust transparency of the rear reflective surface 217.

FIG. 4 illustrates a top view of the mirror 207. As illustrated in this embodiment, the mirror 207 can be generally concave relative to the direction of the light 205 coming from the light source. As the light 205 enters the mirror 207, the concave front reflective surface 215 can be either reflective (to reflect the light off the front surface 215) or transparent (to transmit light therethrough and to the rear surface 217). In another embodiment, the front reflective surface 215 is controlled to be between a total reflectiveness and a total transparency. For example, if the front reflective surface 215 is only partially reflective (e.g., 50% reflective and 50% transparent), the light ultimately reaching the windshield may be less intense compared to if the front reflective surface 215 were 100% reflective. This can adjust or affect the brightness and intensity of the light on the windshield. In one example, more relevant information (e.g., speed, warnings, etc.) can be shown on one zone of the windshield with a brighter intensity, and less relevant information (e.g., engine speed, gear positions, etc.) can be shown on another zone of the windshield with a less intensity.

Utilizing the transparency of the front reflective surface to create multiple viewing zones on the windshield provides several opportunities to better present information to the driver. For example, the controller may command the front reflective surface to be transparent (thus causing an image to display on the first zone 219) in response to a signal indicating a potential for a collision (e.g., via external objects being detected as explained above, etc.). It can thus be said that the front reflective surface can be transparent in response to a safety signal received from one of the safety systems in the vehicle. In another example, the controller may command the front reflective surface to be transparent (thus causing an image to display on the first zone 219) in response to signals received from GPS, such as turn-by-turn directions to a destination, etc. In another embodiment, the controller can be programmed to alter the front reflective surface to assume the transparent state in response to a signal indicating a vehicle speed exceeding a threshold, which can be a speed limit assigned to the street that the vehicle is traveling on.

It should be understood that the switchable transparency may only be provided on a portion of the front reflective surface 215. In other words, the front reflective surface may have a section thereof that is always transparent or always reflective, and another section that is switchable between reflective and transparent. This allows images visible on the windshield to remain visible at all times, while the front reflective surface alters between being reflective and transparent. In one embodiment, half of the front reflective surface is switchable, and the other half of the front reflective surface remains reflective and is not controllable.

While not shown in the figures, it should be understood that the HUD system 113 may includes other structure such as lenses, reflectors, or other components configured to distort the light before the light reaches the mirror 207. Likewise, there may be a structure that interferes with the light after it reflects off of the mirror 207.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost., strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1. A heads-up display (HUD) system for a vehicle, the HUD system comprising:
a light source configured to transmit a light;
a mirror configured to reflect the light onto a window of the vehicle, the mirror having a front reflective surface and a rear reflective surface located further from the light source than the front reflective surface; and
a controller programmed to selectively alter a transparency of the front reflective surface.

2. The HUD system of claim 1, wherein the controller is further programmed to alter the front reflective surface between (i) a reflective state in which the front reflective surface is reflective to reflect the light onto the window, and (ii) a transparent state in which the front reflective surface is transparent to allow the light through the front reflective surface and reflect off of the rear reflective surface.

3. The HUD system of claim 2, wherein in the reflective state, the front reflective surface reflects light onto a first zone of the window.

4. The HUD system of claim 3, wherein in the transparent state, the rear reflective surface reflects light onto a second zone of the window.

5. The HUD system of claim 4, wherein the second zone is larger than or shaped differently than the first zone.

6. The HUD system of claim 2, wherein the controller is further programmed to alter the front reflective surface to assume the transparent state in response to a signal indicating a potential for a collision based on a detection of an external object relative to the vehicle.

7. The HUD system of claim 2, wherein the controller is further programmed to alter the front reflective surface to assume the transparent state in response to a signal indicating a vehicle speed exceeding a threshold.

8. The HUD system of claim 1, wherein the front reflective surface includes liquid crystals, and the controller is programmed to selectively energize the front reflective surface to align the liquid crystals, thereby changing the transparency of the front reflective surface.

9. A heads-up display (HUD) system for a vehicle, the HUD system comprising:
an electronic light source configured to transmit a light configured to provide a driver of the vehicle with information; and
a switchable mirror configured to reflect the light toward a windshield of the vehicle, the switchable mirror including a front reflective surface and rear reflective surface located further form the light source than the front reflective surface; and
a processor programmed to switch the switchable mirror between (i) a transparent mode in which the front reflective surface is transparent such that light from the light source passes through and reflects off the rear reflective surface, and (ii) a reflective mode in which the front reflective surface is reflective such that light from the light source reflects off the front reflective surface and onto the windshield to provide the information onto the windshield.

10. (canceled)

11. (canceled)

12. The HUD system of claim 9, wherein the processor is programmed to switch the switchable mirror from the reflective mode to the transparent mode in response to signals received from external-object sensors configured to detect objects external to the vehicle.

13. The HUD system of claim 9, wherein the processor is programmed to switch the switchable mirror from the reflective mode to the transparent mode in response to a command to display navigation information onto the windshield.

14. The HUD system of claim 9, wherein in the reflective mode, the light reflects off the front reflective surface and reflects onto a first zone of the windshield having a first area.

15. The HUD system of claim 14, wherein in response to the processor switching the switchable mirror to the transparent mode, the light transmits through the front reflective surface and reflects off the rear reflective surface onto a second zone of the windshield having a second area.

16. The HUD system of claim 15, wherein the second area is larger than or uniquely shaped relative to the first area.

17. A switchable mirror for a heads-up display (HUD) system, the switchable mirror comprising:
a first layer having a first substrate;
a second layer directly adjacent the first layer and having a switchable reflective surface;
a third layer directly adjacent the second layer and having a second substrate; and
a fourth layer directly adjacent the third layer and having a non-switchable reflective surface;
wherein the switchable reflective surface is controllable to selectively permit light to transmit therethrough, through the second substrate, and reflect off of the non-switchable reflective surface and to a windshield of a vehicle.

18. The switchable mirror of claim 17, wherein the switchable mirror is arranged relative to a light source such that light travels first through the first layer, then through the second layer, then through the third layer, and then to the non-switchable reflective surface.

19. The switchable mirror of claim 17, wherein the switchable reflective surface includes liquid crystals configured to selectively organize in alignment to enable light to transmit through the second layer and into the third layer.

20. The switchable mirror of claim 17, further comprising an electric switch operable to control an opacity of the switchable reflective surface.
